(19) United States
(12) Patent Application Publication
(10) Pub. No.: US 2016/0243404 A1
(43) Pub. Date: Aug. 25, 2016

(54) ONLINE METHOD FOR CREATING A COACHING PLAN

(71) Applicant: Daniel Keller, Huntington Beach, CA (US)

(72) Inventor: Daniel Keller, Huntington Beach, CA (US)

(21) Appl. No.: 14/850,503

(22) Filed: Sep. 10, 2015

Related U.S. Application Data
(60) Provisional application No. 62/118,898, filed on Feb. 20, 2015.

(51) Int. Cl. A63B 24/00; G09B 5/02

(52) U.S. Cl. CPC A63B 24/0075; G09B 5/02; A63B 2024/0081

(57) ABSTRACT

A method and system for organizing and implementing a coach's practice or game plan using pre-stored templates and libraries of media, drills, and exercises that can be selected by a user to create a custom plan. The system and method incorporates a timer to keep a plan on schedule and alarms that ensure compliance with the schedule. The plans can be shared with players, and homework assignments generates and communicated via the application.

### CROSS-REFERENCES TO RELATED APPLICATIONS

This application claims priority from U.S. Application No. 62/118,898, filed Feb. 20, 2015 incorporated by reference in its entirety.

Managers, coaches, and trainers that prepare athletes for competition typically train their athletes outside of game day activities at workouts or practices. Practices are where the athletes learn their skills, under the guidance of the coaches, and improve their abilities in their chosen sport. Practice is also where endurance, strength, and instruction are drilled into the athlete, allowing the athlete to compete as his or her highest level. From peewee sports to Olympic events, the importance of well run, organized practices is critical to a team's or an individual athlete's success.

### BACKGROUND

Coaches who organize and run practices tend to have a set pattern, which in many cases is gleaned from workouts and practices dating back to when they themselves were athletes. While new methods are introduced all the time, the challenge of designing and organizing an efficient, focused practice routine is always more difficult than it sounds. For any new coach or parent who volunteers to coach a youth team for the first time can attest, despite their best intentions practices tend to be loosely run, disorganized, and inefficient in all but the most limited cases.

The reason many practices are inefficiently run is that the coach or trainer lacks a comprehensive plan for achieving the goals necessary to compete at the highest level. Coaching plans, to the extent they are preplanned, tend to be hastily sketched out on paper or notebooks, and the activities often revert back to the familiar. There are no well understood and available methods for creating and implementing a coaching plan that details a practice or a set of practices, where the coach can assign time periods and include instructional video to teach the athletes exactly what is expected of them. The present invention is intended to fill the void in the coaching discipline by implementing an online method for creating a coaching plan that can be created by a coach or trainer and distributed to a team, and where the plan can include instructional video to assist the athlete, and the practice plan follows a larger athlete development plan/curriculum.

### SUMMARY OF THE INVENTION

The present invention is a website accessible via a hand-held device that utilizes pre-stored practice routines, exercises, and media in a user-friendly environment built around coaches and players and the advancement of players and teams through a series of training videos, equipment lists, skills information and other pertinent information regarding athletic development. The web site, or a software application, runs on a smartphone, tablet, or the like, to assist coaches anywhere with an internet connection and allow the coaches to educate themselves, plan practices, implement practices, teach skills and further the advancement of their teams and individual athletes. The application or access to the website may be made available to the public through a subscription (paid) based service, or it may generate revenue through the sale of advertising on the site or application.

The invention will include an infrastructure that includes a database that may be continually updated and revised, and accessed by the coaches/subscribers. The proprietor of the website or application has administrative control to allow updates, uploading of new material, and otherwise edit all features of the website. The website or application includes at least one mode of communication whereby coaches can seek answers to questions regarding the training or coaching techniques, such as email, text messaging, instant messaging, forums, or the like. Another feature allows the user to access social media outlets and contribute to such outlets via the website or application. In addition, the website or application includes search capabilities that allow users to query the system to investigate topics of interest, techniques, exercises, new practice regiments, etc.

The present invention includes unique sequences of practice regiments during designated or flexible time intervals to better assist the athletes in preparing for games and refining their techniques. The invention can also be used to stream video and audio of “live” practices, where expert coaches run their athletes through an actual practice that can be attended “virtually” by coaches anywhere in the country. Alternatively, the coach or trainer can create a new practice plan, and then share the plan online with other subscribers. The application can include a “Start” button associated with that practice plan, which initiates an executive assistant to help the coach manage the practice. That is, the selected drills scroll across the screen in real time, complete with 2-minute warning sounds, horns/verbal instructions to switch stations and move onto the next drill. The practice can include rest and water breaks, question or discussion periods, and teaching segments. Parents associated with the team can track the progress of the practice and click to view instructional videos associated with the drills being run. The application sends push notifications regarding weather issues, location changes, and even sends a reminder when the practice is concluding that can be used by parents to signify that it is time to pick up their athlete from practice.

These, and other features of the invention will best be understood by reference to the detailed description of the preferred embodiments below, along with reference to the accompanying figures.

### BRIEF DESCRIPTION OF THE DRAWINGS

FIG. 1 is a schematic diagram of different types of accounts for the present invention;

FIG. 2 is a schematic diagram of basic elements of the program of the present invention;

FIG. 3 is a flow chart diagram of different functions for the application of the present invention;

FIG. 4 is a flow chart diagram of the game plan generator and its preferred options;

FIG. 5 is a flow chart diagram of a publishing option of the application;

FIG. 6 is a flow chart diagram of a coach's plan information template;

FIG. 7 is a screen illustration of a home screen of the present invention;

FIG. 8 is a screen illustration of a coach's plan creation template;

FIG. 9 is a screen illustration of a sample template for a coach's plan;

FIG. 10 is a screen illustration for a homework generating template; and

FIG. 11 is a screen illustration of a real time coach's plan display.

### DETAILED DESCRIPTION OF THE PREFERRED EMBODIMENTS

The present invention is intended to be a complete practice and game planning solution powered by videos, drill descriptions, equipment lists and practice planning templates. A web site or software application provides an all in one practice planning and game planning tool comprised of three major parts: (1) A database library comprised of “how to” videos instructing users “how to” run drills and coach a team sport, such as baseball, (2) A database library of pre-set template practice plans organized by age/division/organization, which can be selected, modified (or left as is), and shared to team parents, coaches, and members; and (3) A template driven, drag-and-drop planning tool to construct specific team practice plans and share them with a list of contacts, potentially made available through a subscription based system. The website or software application (or a combination thereof) may also add an advertising platform that will allow a proprietor to sell advertising to participating vendors and display banner or text based ads throughout the site.

The website or software application includes a home page that invites new users to sample videos, sample content and information regarding the “Practice Planning” tool. Sponsor ads, news feed, and social media links may also be incorporated onto the home page. A newsletter sign-up opportunity can be linked on the home page, and a slideshow featuring sample content is available to new customers. The opportunity to purchase training aids and supplemental products will also be available.

The home page will link to content pages where training exercises, advice, instructional videos, pre-planned practice templates, and other teaching tools are available. As the system grows, adding and removing content pages from the CMS system will occur to manage the system and replace outdated information with current information. Each content page will preferably include side bar items that are chosen based on the individual pages. For example, hitting instruction content pages may include side bar items such as batting glove suggestions, hitting aids, and batting cage advertisements. Each content page includes links to a video library where instructional videos are available for viewing or downloading. A search window is preferably located at the top of every page, so that a user can conduct a search of the system from any page to investigate other topics or activates within the system.

The system will further include a library page, that will include advanced content or in-depth materials for further enhancement. The library page can include links to drill videos (library/content management), drill specifications or information, diagrams, suggested equipment, topics of conversation (e.g., bulletin boards), recommended products and services, endorsements, and professional coach/athlete provided content.

A key feature of the system is a drill page, where a full screen view of a selected drill is made available to the user. The drill page also includes a title of the video/information, video or image followed by the content/bullet items, diagrams, proprietary key tips and recommendations called “DC Keys”, and a series of links at the bottom of the page to share or add to favorites. This feature allows users to share a limited number of drills within a designated time frame. This feature, for example, may allow a coach to share a video with his or her players, prior to the practice in which the activates are to be undertaken. This allows the athletes to investigate and understand the maneuvers needed to perform the exercises, and can speed up the learning and improve the efficiency of the practices.

Another key feature of the system is a game planner page with a fillable roster/lineup card for the coach's convenience, including participation totals, and suggested guidelines for playing time and positions played. The roster/lineup will then be printable or sharable with the coach's team/contacts. In a preferred embodiment, the web site or software application will include testimonials submitted by all levels of users with the opportunity to share these testimonials through various social media outlets. Administration may moderate contributions on this page from the CMS system.

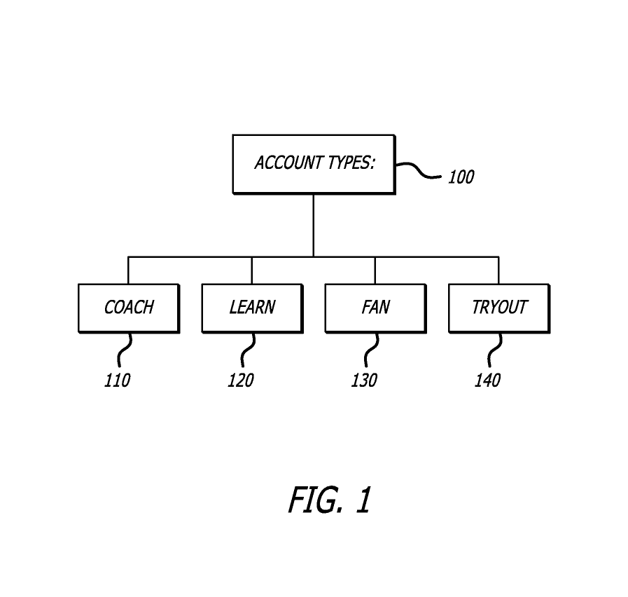

In a preferred embodiment, the system includes subscription levels for the purpose of building a database of coaches and players through registration, and information provided to each user will be based on their subscription level. Subscription pages will be a secure registration form with the option to purchase advanced subscription levels at a designated cost. For example, in one embodiment there are three distinct subscription levels. FIG. 1 illustrates the various account types 100.

COACH SUBSCRIPTION—The first type of subscription is a coach subscription 110, granting full access to a library of drills/videos and associated content, a library of practice plan templates, and practice planning tools as well as all other aspects of the website. Coach subscriptions are able to utilize the advanced features of a mobile application including the practice planning tool, library access, and practice assistant, as well as the basic features (“view-only) of the mobile application. They can track progress through notes, capture images and video (and tag to any drill and any team player), and assign and share homework plans.

LEARN SUBSCRIPTION—The second type of subscription is a “learn” subscription 120, granting access to a library of instructional drills/videos and associated content. Learn subscriptions are able to utilize advanced features limited to library access of instructional drills/videos, as well as the basic features (“view-only”) of the mobile application. Learn subscriptions can use the ‘share’ feature to construct and share homework assignments to other members.

FAN SUBSCRIPTION—The third type of available subscription is a fan subscription 130, permitting a limited or trial access to the drill library with no access to the practice planning tools, other than a “view only” version of a plan that is shared from another member who has the coach subscription. Fan subscriptions are unable to access and utilize the library and practice plan templates, or the practice planning tool. Fan subscriptions may be limited to basic features (“view-only”) of the mobile application, which include a live-practice page, notifications regarding pick-up times, weather alerts, or change-of-location fan members are only be allowed to view the coach's plan for a limited amount of time before the plan expires (e.g., five days).

TRIAL SUBSCRIPTION—The trial subscription 140 only allows the user to view sample videos/information designated by administration. This may include the ability to allow access to basic members of a “Drill of the Week” or allow access to a limited number of videos/information before revoking access and recommending subscription. Basic members are only be allowed to view the coach's plan for a limited amount of time before the plan expires (e.g., five days).

The website or application includes a home page to initiate newcomers and direct existing users to the various functions of the site/app. The home page may include sample videos to entice new subscribers, sample content and information regarding the practice planning tool. Testimonials, sponsor ads, RSS news feeds and social media links may also be displayed on the home page, as well as a newsletter sign-up option and a slideshow that features content of the site/app. Navigation is determined by the content as it grows and collects in various forms, overseen by a content management system.

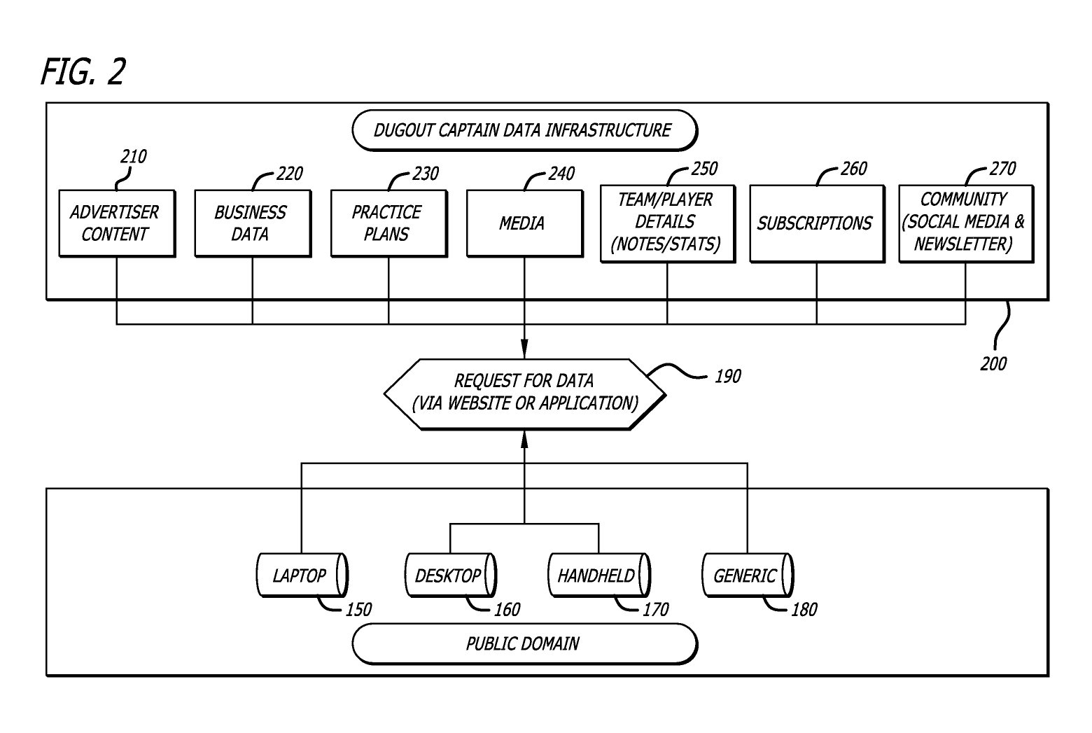

FIG. 2 illustrates a flow chart linking various aspects of the system and method of the present invention. Requesting device can include laptops 150, desk top computers 160, hand held devices 170 such as smart phones, tablets, etc., and other generic requesting devices 180. The various requesting devices are connected to a portal 190 via connected (wired or wireless) communication systems such as cellular networks, local area networks, the internet, wifi, and the like. The portal 190 is connected to the Dugout Captain information storage and retrieval system 200, which includes several components. A first component is an advertising content storage module 210 that can be used to insert/transfer advertising content into the program. The advertising module can utilize keywords to focus advertising to specific users based on requesting content, incorporate links and advertisements as part of banners or dedicated ad locations in the user's pane. The ads can rotate or be updated to increase views of all ads and revenues.

A second module is the business data module 220, that tracks customer information, financial information, and the like. Credit card information, payment renewals, customer personal information, and the like are stored in the business data module 220. A third module is the practice plan module 230 used to store coach created practice plans as well as templates and sample plans. Media such as videos, pictures, illustrations, audio instruction, and other recordings are stored in the media module 240, which can be retrieved as well as incorporated into the practice plans. The library of instructional videos are stored in the media module and accessible at any time through the application or web site to subscribers. Access to the various videos and content can be tiered to subscriber levels, as well as options such as duration of access, ability to share with other users, and ability to contribute to the media library.

A team/player module 250 stores information about a team or player that can be accessed by certain subscriptions, as well as used when publishing or transmitting plans or deliverables to the clients/customers. Another module is the subscription module 260 that keeps an inventory of the various subscriptions attributed to the various users, as detailed above. Because access is contingent on the subscription level, the other modules must share this information in carrying out their respective functions. Finally, a media outlet module 270 is used to publish newsletters, blogs, announcements, testimonials, share items through social media, and the like.

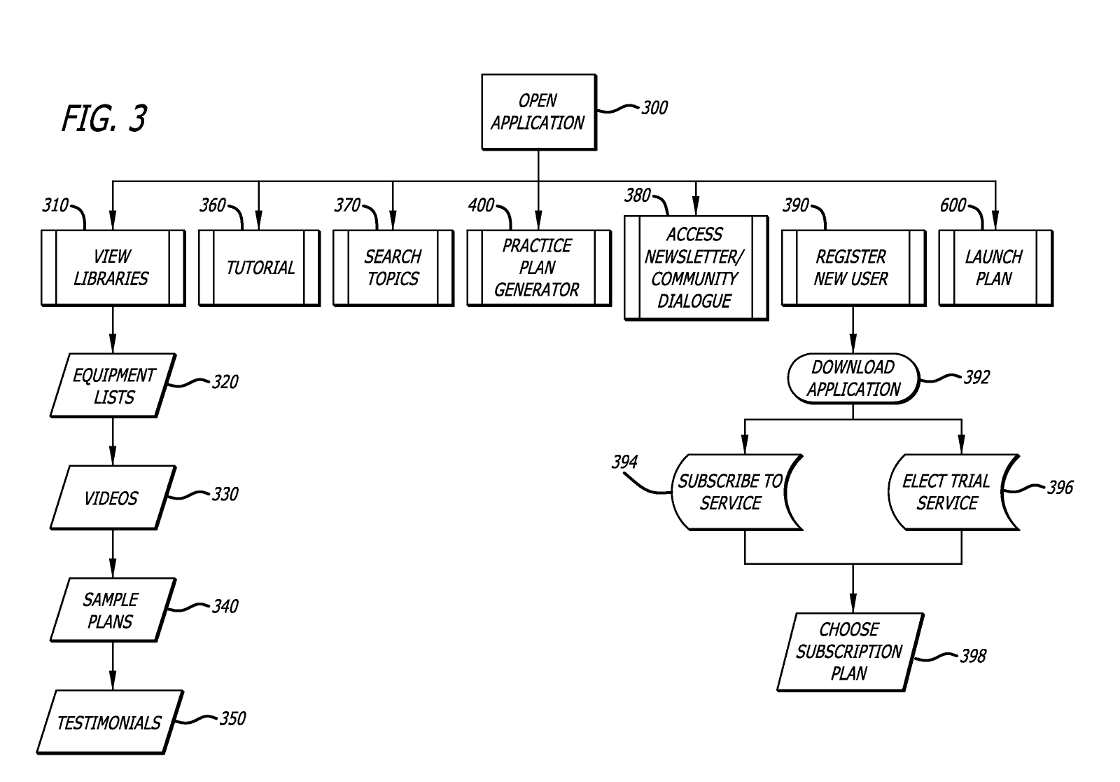

FIG. 3 is a flow chart that illustrates the options that may be available to certain subscribers from either a web site or an application on a smart phone, hand held device, or the like. Upon opening the application 300, a user may view libraries 310 of information, e.g. equipment lists 320, instructional videos 330, sample coaching plans 340, and testimonials 350. A tutorial link 360 allows new users to navigate the application or web site with frequently asked questions, navigation tips, and helpful information on how best to use the application. A search engine 370 allows the subscriber to search for topics of interest quickly and efficiently, and the community link 380 grants access to message boards, newsletters, blogs, as well as providing a communication avenue to the proprietors of the application. A new user link 390 can be accessed by new users to download any software or applications 392, and select a subscription 394 or choose to participate in a trial service 396. From there, a specialized subscription plan 398 can be selected based on the user's needs. The two remaining options are the practice plan generator module 400 and the launch plan module 600.

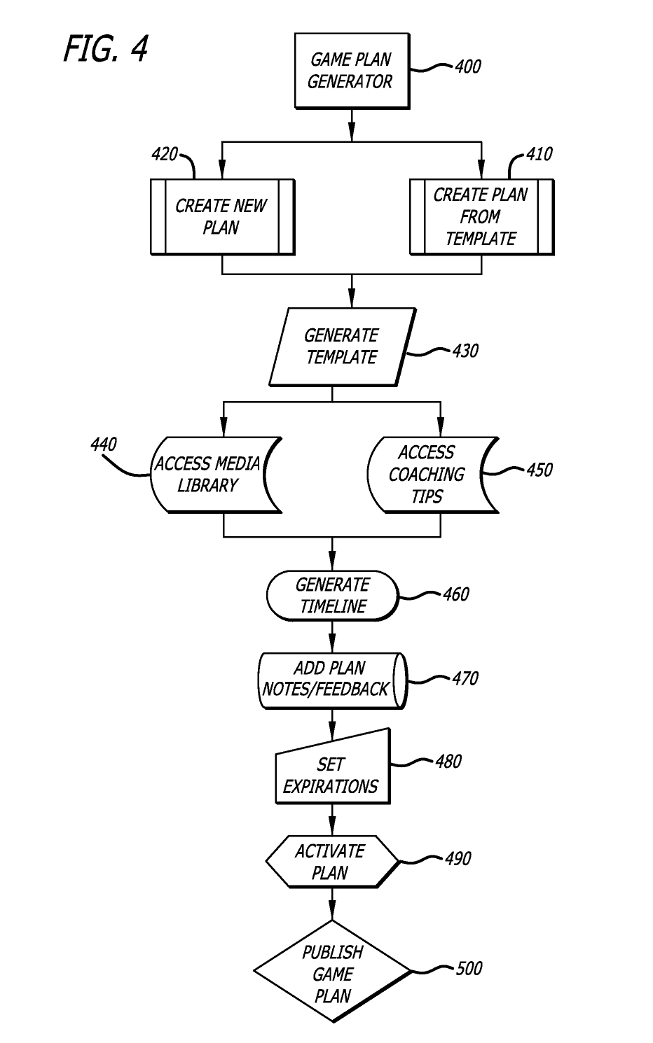

FIG. 4 illustrates the steps in the practice plan generator module 400. Note that while the term “practice plan” is used, the module can be used to create a broader range of products, including line-ups, player rosters, game plans, etc. Initially, the subscriber/user can elect either a template driven plan 410 or create a new plan from scratch 420. In either case, the plan builder module 400 generates a new format 430 that can be populated with media 440 from the media module 240 as well as coaching tips and information 450. This data is collected and formatted into a timeline 460 based on the anticipated duration of each activity/session/exercise. The user can incorporate feedback and notes 470, which become a permanent part of the plan and can be reviewed and modified after each practice. An option is permitted to set an expiration 480 on the coaching plan, so that it cannot be viewed or transmitted after a certain period of time. Once the plan is complete, it can be activated 490 via the launch plan builder 400 module, and may be published 500 to players, parents, other coaches, other subscribers, etc.

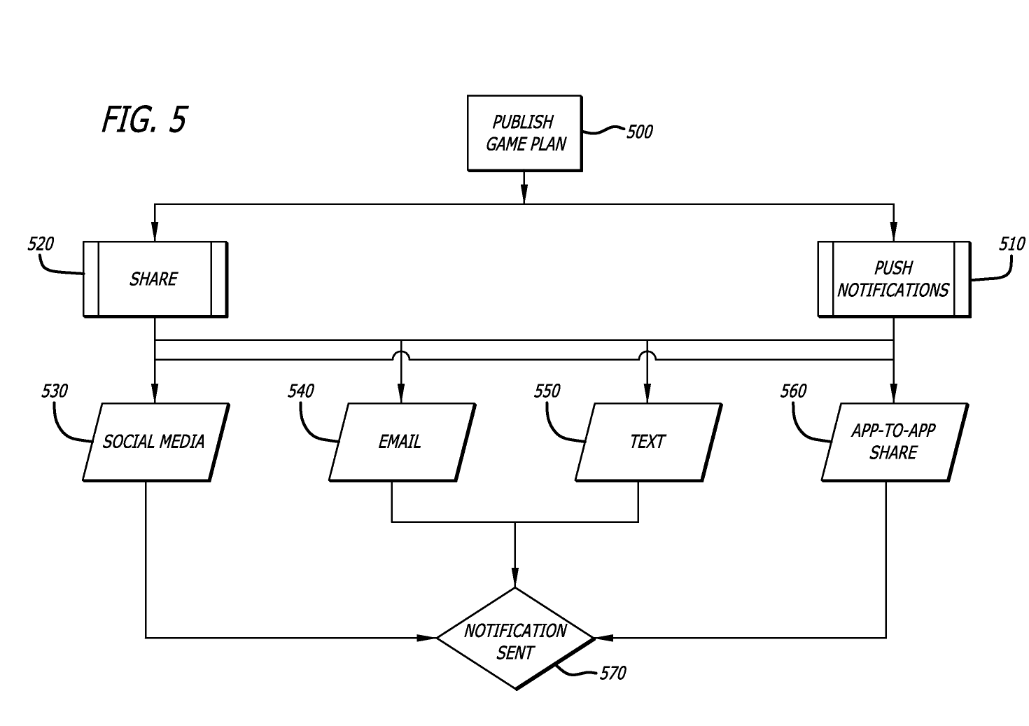

FIG. 5 illustrates the publishing function 500 of the application, which includes both push notifications 510 as well as share options 520. The modes of communicating the plan created through the launch plan builder module 400 can include social media (Twitter, Facebook, Periscope, etc.) 530, email 540, text messaging 550, application-to-application sharing 560, and other modes of data exchange. In each case, a notification 570 may be sent to subscribers and potential subscribers that a plan has been created and is now available.

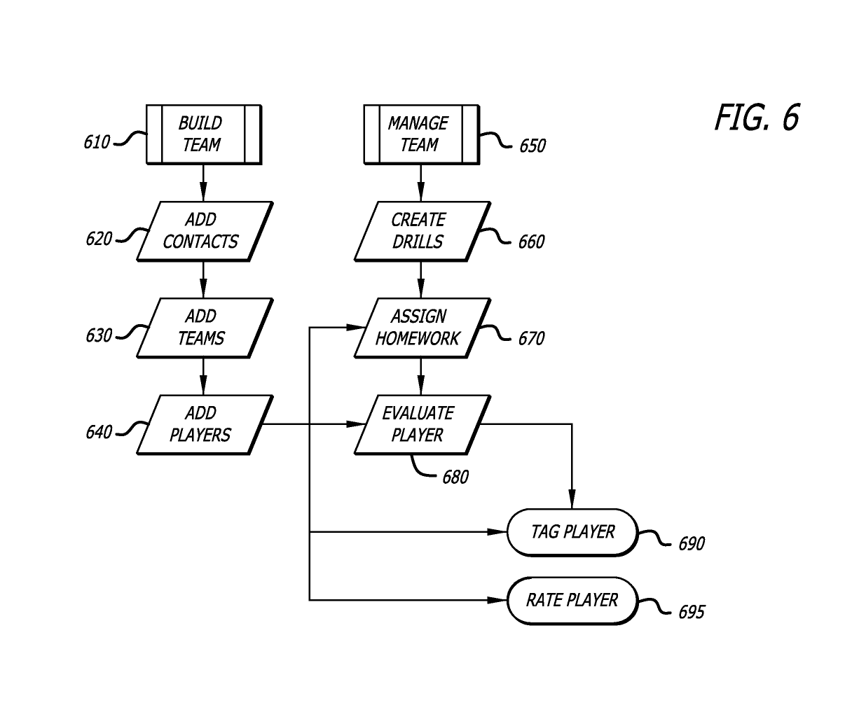

The game plan generator 400 can also incorporate several functions that are illustrated in FIG. 6. A manager can use the game plan generator to create a plan for a specific team and tailor the game plan for individual players on the team. A manager can begin by creating a team 610 and entering his/her players, incorporating contacts 620 and adding additional teams 630 and players 640. Once the teams and players are established, the manager can use the application to manage the team in various ways, such as creating practice regiments and drills 660, assign team and individual homework assignments 670, evaluate players performance and track progress 680, tag a player for future consideration or attention 690, and rate players 695.

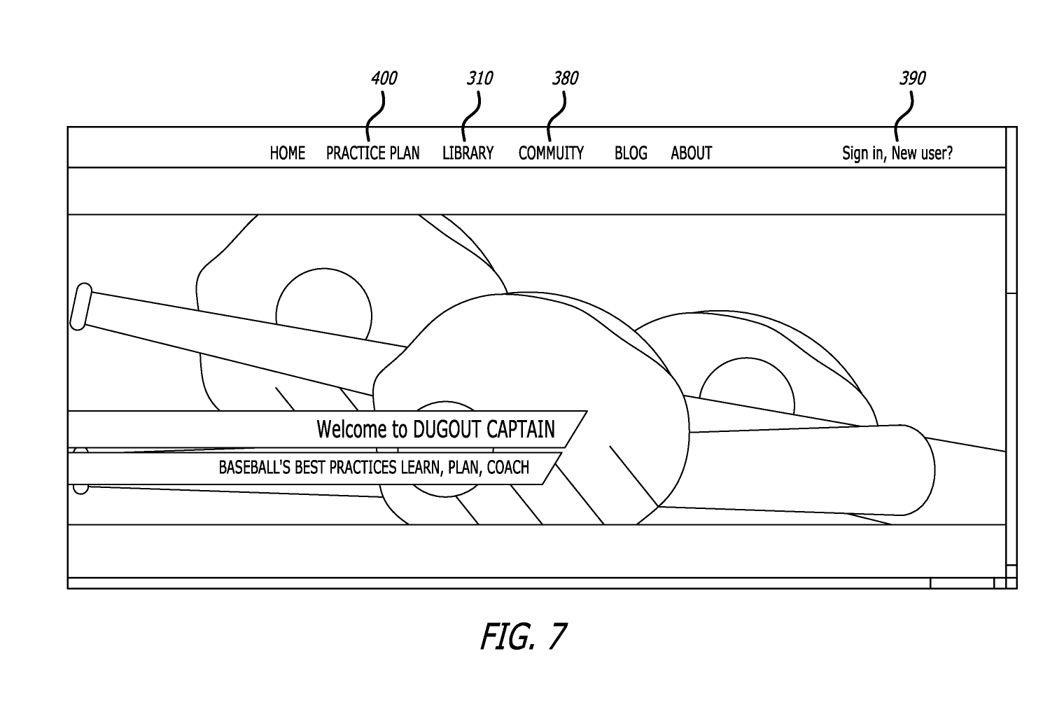

FIG. 7 is a sample home screen for a web site or application that runs the software that makes up part of the invention. The home screen includes links to the library module 310, the community link 380, the new user module 390, and the game plan generator 400. Other features and options can also be incorporated in the home page, or in secondary pages of the application or web site.

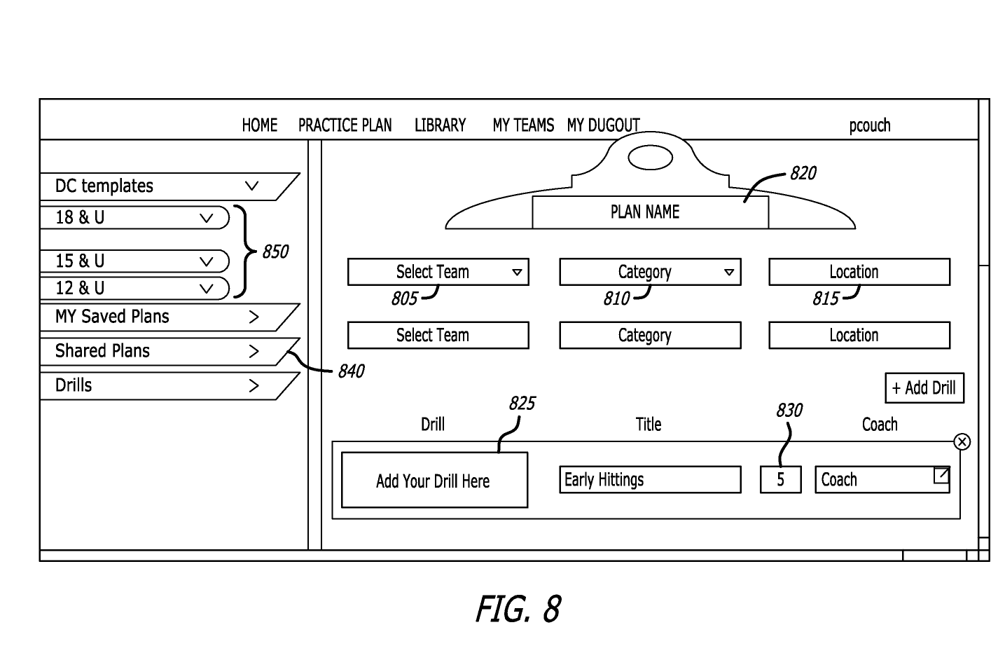

FIG. 8 illustrates a screen shot for the game plan generator module 400. A template is available to populate the plan with information about teams categories 805, categories 810, locations 815 to create a practice plan. The practice plan can include a “name” field 820, and a list of windows 825 to be filled by the coach with activates that make up a practice. Each interval can be mapped out using media from the library as well as notations, using a drag and drop system or other methodology to fill out a practice plan. Each section is selected by the coach, supplemented if desired by video or other media to more clearly spell out what is expected of the athletes. Each “plan” can be saved and reused or used as a starting place for the next practice, building on lessons learned and drills mastered to advance the athlete or player to the next level. Various modes are available to share the plan, using print or electronic means to communicate the plan. For example, the plan can be “pushed” to Dugout Captain mobile application for viewing by registered LEARN or FAN members, emailed from the coach to LEARN or FAN member players or parents, or uploaded to a team website. A hardcopy can be printed and distributed to the players. Social media can also be used to share the plan, where copyright protection and copying protection may be used to prevent unauthorized replication of the plan. Practice plans may also be made perishable in nature and expire from FAN membership viewing access after 5 days.

This plan creating tool allows coaches to create a full practice plan from several key components. The basic feature of the planning tool is the capability to build an individual, custom practice plan from a library of media inside a pre-arranged practice template. The template consists of several sections that permit the coach to create a plan within a specific time allotment. In each template, a time slot drop down 830 is pre-populated with a suggested time frame, but the tool allows the coach/user to change that time allotted. A field is displayed that enables the coach/user to choose from our extensive library of drills, information, suggestions or other topics. Once a drill is selected, a field is displayed that enables the coach/user to select a coach to run that specific drill.

A timeline at the bottom of the screen dynamically adjusts based on the time chosen for the entire practice, and when a drill or exercise is chosen the time selected is deducted from the dynamic timeline. Once the timeline is full, the coach/user will not be able to add more content unless they adjust the total practice time or the time allotted for a specific drill or exercise. Each activity may be edited (both name and content) as well as removed if the coach/user decides against the activity. Thus, the coach/user has total control of what appears in their specific plan.

To build a practice plan from the Dugout Captain “best-practices” template, the coach/user follows an eight-step process selecting a single drill for each suggested section. The sections follow chronologically: (1) Early hitting, (2) Warm up, (3) Early Base-running, (4) Throwing, (5) Quick Defense, (6) Station Instruction, (7) Base-running; and (8) Finish/Mental training.

To build a practice plan from a pre-established plan, the coach/user selects an entire plan from a menu 840 that populates each period with selected content. This feature fills out the practice plan for a coach/user based on established practice plans in the library and selected by the manager of the system. These pre-established plans may be created by other coaches or professionals, and each plan may be cataloged by age group or skill level 850. In certain cases, practice plans work together to achieve coaching advancement through an athlete development plan.

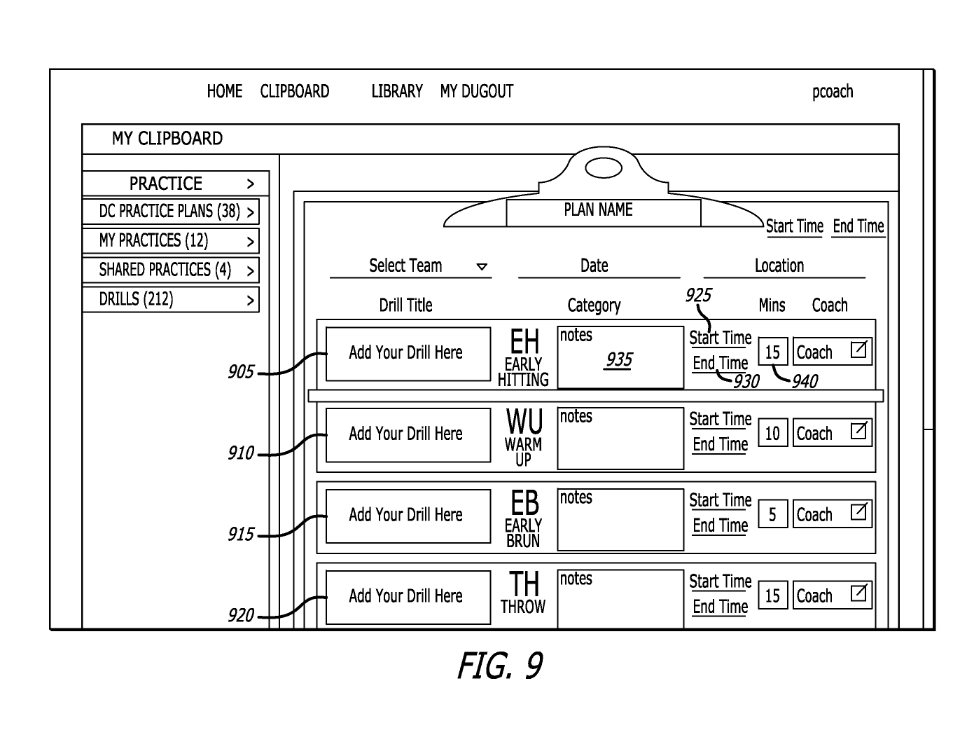

To build a practice plan from scratch, the coach/user begins with an empty template and begins with the first period, adding content and assigning (if unassigned) a time allotment for the period. This feature allows the coach/user to take a blank slate and add the drills, exercises, and activities that he/she wishes to utilize in the practice plan. At any time, a coach/user can select one of the drill blocks from the scrolling menu bar, which takes the user to a Drill/Segment page (FIG. 9). The user can select any drill and drag to a time-block on the virtual clipboard and assign a team coach/contact as leader. For example, the first block may be “Early Hitting” 905, followed by “Warm Ups” 910, “Early Base Running” 915, and “Throwing” 920. Each drill has a start time 925 and stop time 930, a time allotment 940, a place to enter notes 935. A number of different plans can be created, named, and assigned to different teams or coaches to meet the needs of each team and coach.

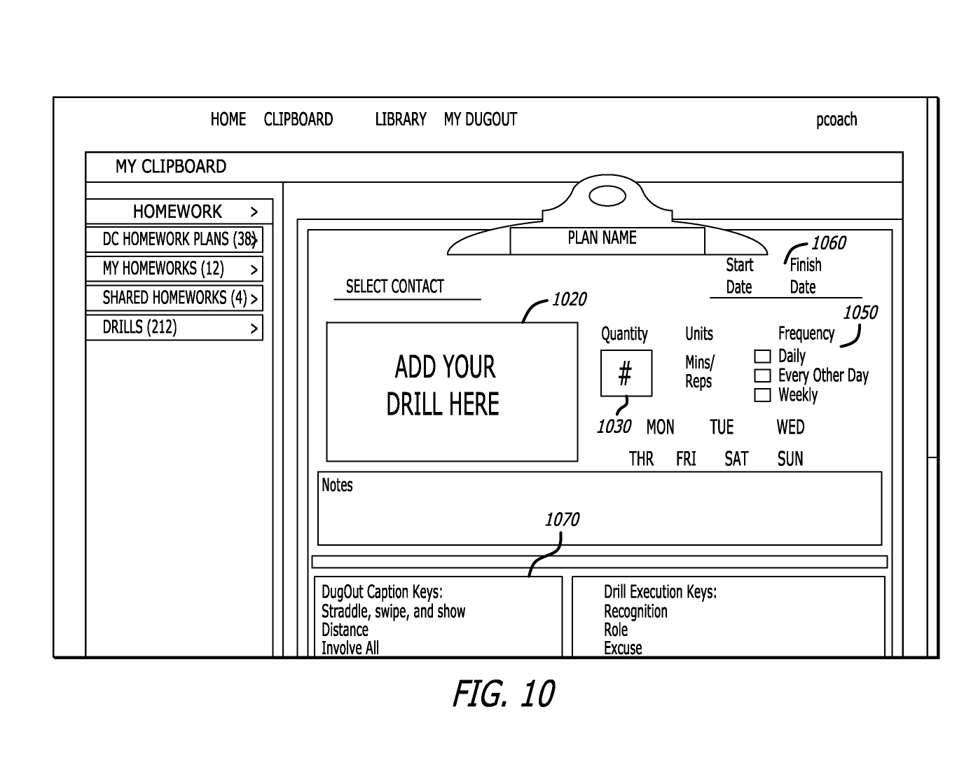

FIG. 10 illustrates a Homework option that a coach can create and assign to an individual player or athlete. The homework page can be used to create individual homework for a player based on practices, games, or other perceived strengths and weaknesses. The page includes a window 1020 for media such as video, including instructional video or video of the player in action. The page can include number of repetitions 1030, information about the exercises 1040, frequency 1050, and due dates 1060. A box to provide additional notes 1070 allows coaches to add tips and strategies to the athlete for use with the exercises.

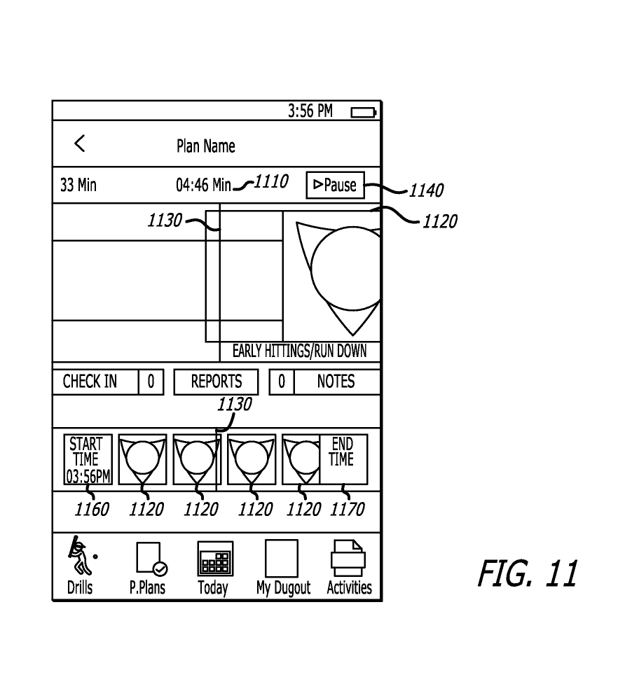

FIG. 11 illustrates another screen shot of a live plan mode where the practice (i.e., coach's plan) is run in real time and the progress of the practice can be monitored by the coach, parents, other coaches, and in some cases the players themselves. A running clock 1110 is prominently displayed, which may show the time of day, the timer for establishing the practice, or a countdown timer until the end of the practice. Each period 1120 corresponding with a drill or exercise is scrolled across the screen past a “current” bar 1130, showing exactly where in the practice the team is currently in, how much practice is left to be completed, and when parents might leave to pick up their athlete. The interface may include notes and check in status, as well as reports. The timer 1110 can be controlled in some cases by a pause button 1140 where practice is either interrupted or where drills have run long for unexpected reasons. The status bar 1150 shows a start time 1160, a completion time 1170, and the current period or drill. In a preferred embodiment, the interface may also include a screen to show exemplary drill exercises, such that parents and athletes can evaluate the progress and compare the skills with an exemplary drill as the drill is occurring.

To manage a newly created plan using the practice planning tool, a preferred embodiment uses a drag and drop methodology whereby content is selected from the available library, and dragged to the practice template where it is automatically entered into the practice period. All library content can be dragged into the template as well as the drill preview screen that is included on the left hand side. Options for naming and saving the plan includes naming the plan, the location, team, and date. Each drill in the library includes a brief description of the activity in a pop up window. The coach/user will have the option to change an allotted time, dynamically adjusting the timeline at the bottom of the plan screen. A timeline is dynamically generated in a designated field similar to video editing software. This allows the coach to track his practice times to fill a specific practice length. This timeline begins to add as the coach chooses activities for each period. As an example, when a coach chooses the “Early Hitting” activity the timeline automatically increases by twenty minutes. The coach can edit this time to meet his goals and available time.

Another option available to the coach is the availability for station blocks, where players break up into position units, or small groups for individualized instruction. Station blocks allow the coach to “split up” a block of time into multiple drills. The pre-arranged template may start with two blocks, but the coach/user has the option to add or subtract blocks as he sees fit. Each time block may start with two drills, but the coach/user has the option to add or subtract additional drills as well.

In a first preferred embodiment, users will subscribe to the application and may avail themselves of the planning tool and the media and content in the library. Subscribers (players, parents) can access plans “shared” to them from Coach-Members. Practice plans are shared once the member has completed the registration process. Practice plans are available for a limited amount of time (current estimate is 5 days from “sharing” by a COACH member/user). At the basic subscription level, only a few sample videos/information may be available outside of those drills included in shared practice plans (within the five-day perishable time frame).

Team sharing pages are forms that allow the coach to add users to his or her team, using a roster or list of contacts. Functionality is limited based on the subscription level but will require a basic level of entry fields to capture selected information about the athlete/player. Once a user fills out this form and transmits it, registration may be undertaken and the application gives the member the opportunity to visit the website and subscribe to the application or website. All information is stored in the database with access to the administration to push notices out to each person utilizing an opt-in and opt-out system. Once registered, the users will agree to receive these notices from the website.

Advanced functionality begins with the coaching level, which allows the coach/user to create a team with a list of specific contacts. This also enables the coach to push or share his plan or recommended drills to a specific list of contacts. Team creation allows the coach an opportunity to give a name and a small amount of information to describe the team for his own personal reference and for sending preferences. Once the coach/user creates a team, he will have the opportunity to add contact and edit contacts, select or identify assistant coaches and team administrators, and the opportunity to create multiple teams within their subscription.

Once a member registers from the coach's entry, the coach/user no longer is able to edit the contact information for that user. The Coach/user is only allowed to remove this contact from his list of contacts or teams. Administrators of the application or website have the ability to limit the number of teams a coach is allowed to create, subject to subscription levels.

To begin using the application, a coach creates a team of players, coaches, contacts and their email addresses. Each user will receive an email inviting them to subscribe/register to the website or application so that they may view the coach's practice plan for the upcoming practice. As an example, player 1 selects the link embedded in the email from a computer, redirecting player 1 to the registration page within the website. When player 1 registers, he is given access to the coach plans and the library media content for that subscription plan and level. Player 1 now has complete control over the contact information and the coach can no longer change player 1's information, other than to remove the player from the list.

Player 2 may also select the link in the email from a mobile device. The system recognizes this visit as coming from a mobile device and recommends the mobile application for that device. Player 2 may then register as a player, pay for his subscription, and thereafter lock the coach out of the contact editing. Player 2 may then access all of the available media content for that subscription plan and level. Players may also be granted a limited time “trial” subscription, where limited access is granted while players or other members test out the site/application.

At the bottom of the page of a member having a coach's subscription, there is a share button. After completion of a plan, a coach can then select the share option and a new window opens with a listing of contacts (and a select all tab). From this list of contacts (previously input), the coach can quickly choose with whom he wishes to share this plan. This screen can mimic the team sharing page with the ability to add, edit, and modify the listing of contacts.

Advertising banners and links may be implemented to increase revenue for the website. Rotating or static placement ads may be incorporated into key areas of the site. The management of the system incorporates a robust subsystem for tracking and reporting on all advertising banners input into the website. Banner and text advertising are strategically placed throughout the website and the advertising modes have the ability to be tagged, enabling ads to be displayed based on specific content (drills, information, etc. . . . ).

When a plan is selected, a virtual clipboard is displayed. The virtual clipboard includes the practice plan name at the top, along with certain team information such as name and date, logo, etc. Along the left hand side of the display is a sequence of times corresponding to events in the scheduled practice, starting with the start time for the practice. Each subsequent time may include either a link and/or thumbnail of a video, and a title and brief description of the exercise/activity to be conducted at that time. The sample practice plan includes identifiers to designate a coach assigned to the particular activity, and its duration can be determined by the scheduled start of the next activity. Alarms, both audio and video, can activate at the end of the designated period, alerting the coach that the next activity is scheduled to begin. A vertical scroll bar allows the user to move up and down the practice plan, and the scroll bar can be linked to a clock to automatically move the scroll bar/current activity to match the scheduled time. In this manner, parents can evaluate the remaining time for practice and can also make decisions on what parts of practice to attend depending upon the parent's preferences. The video links allow the players and parents to view the activities before the practice and become familiar with the exercises, which reduces the instruction time and increase the efficiency of the practice.

The present invention utilizes the knowledge and information garnered from years of experience and coaching by the present inventor, in a user-friendly website environment built around coaches and players and the advancement of players and teams through a series of training videos, equipment lists, skills information and other pertinent information regarding baseball development. The present invention enables sports team's coaches in particular across the country with an opportunity to educate themselves, plan practices, implement practices, teach skills and further the advancement of their teams and individual players.

CURRICULUM—The present invention involves a thorough curriculum for development of the youth athlete. This sport-specific curriculum involves a chronological narrative, coaching and management tips, as well as pre-determined practice plans organized by age levels. Each age level contains bullet-point learning objectives, to which achievement is guaranteed by following the practice plans and supportive material. A support network comprised of an interactive coaches corner, bulletin boards, and periodic clinic offerings complete the curriculum program.

MYDUGOUT—Coach's area where he can take notes on drills used. Back end to store team data, practice plans, etc. Has functionality to store images/videos that can be tagged to a specific drill as well as a player. Ranking or evaluation process, and Homework” feature which utilizes our sharing on a limited format. Select a drill, add descriptive text, image, quantity, etc. and assign/share to DC member. MYDUGOUT also involves a front end where he can connect to social media, connect with other coaches, display rec league coaching info, club ball coaching info, and potentially offer services (trainers etc).

I claim:

1. A method for generating a coach's practice plan, comprising:
establishing an account of a user with a subscription level;
granting access to pre-stored media library associated with the subscription level;
generating a practice plan template that may be customized by a user;
populating the practice plan with drills including media from the pre-stored media library;
communicating the practice plan to a player based on the player's subscription level; and
creating a homework assignment for player that can be communicated to the player electronically.

2. The method for generating a coach's plan of claim 1, further comprising a plurality of subscription levels associated with different access to content.

3. The method for generating a coach's plan of claim 1, where the coach's plan is accessible wirelessly using a handheld device.

4. The method for generating a coach's plan of claim 1, wherein advertising can be automatically incorporated into a coach's plan.

5. The method for generating a coach's plan of claim 1, wherein topics can be searched using a search engine and the results used to populate a coach's plan.

6. The method for generating a coach's plan of claim 1, wherein a plan may be created or a pre-saved plan can be used.

7. The method for generating a coach's plan of claim 1, where an expiration date on a plan can be incorporated that precludes use of the plan after a set date.

8. The method for generating a coach's plan of claim 1, further comprising push notifications that can be sent to recipients of the coach's plan to alert recipients of an availability of the coach's plan.

9. The method for generating a coach's plan of claim 1, further comprising tagging a player in a coach's plan for future evaluation and notification.

10. The method for generating a coach's plan of claim 1, further comprising displaying a dynamic timeline that indicates a point in time of an ongoing practice plan and a remaining time of a plan.

11. The method for generating a coach's plan of claim 1, further comprising a real time broadcast of a practice plan to allow remote tracking of a practice plan's progress.

12. The method for generating a coach's plan of claim 1, further comprising an application-to-applicant data sharing to allow subscribers to share coach's plans.

13. The method for generating a coach's plan of claim 1, further comprising a tutorial video for navigating an application.

14. The method for generating a coach's plan of claim 1, further comprising dynamically generating a timeline that adjusts when a drill is elected as part of the coach's plan, where an allotted time for the drill is deducted from an overall coach's plan timeline.

15. The method for generating a coach's plan of claim 1, further comprising adding copyright protection to a newly created coach's plan.

16. The method for generating a coach's plan of claim 1, further comprising an alarm emission when a time allotted for a drill expires and a new drill is to begin.

17. The method for generating a coach's plan of claim 1, further comprising a real time status indicator for tracking a progress of a coach's plan.

18. The method for generating a coach's plan of claim 17, further comprising a status bar with a start time and an end time for the coach's plan.

19. The method for generating a coach's plan of claim 17, further comprising a scrolling list of drills in each coach's plan and a current bar to indicate a present status of the list of drills.

20. The method for generating a coach's plan of claim 17, further comprising a pause button to temporarily pause a running timer for the coach's plan.
